(19) United States
(12) Patent Application Publication
(10) Pub. No.: US 2025/0249695 A1
(43) Pub. Date: Aug. 7, 2025

(54) TAPE PRINTING APPARATUS AND METHOD FOR CONTROLLING TAPE PRINTING APPARATUS

(71) Applicant: SEIKO EPSON CORPORATION, Tokyo (JP)

(72) Inventors: Kenji MOTAI, Matsumoto-shi (JP); Taishi Sasaki, Shiojiri-shi (JP)

(73) Assignee: SEIKO EPSON CORPORATION, Tokyo (JP)

(21) Appl. No.: 19/042,157

(22) Filed: Jan. 31, 2025

(30) Foreign Application Priority Data
Feb. 2, 2024 (JP) 2024-015070

(51) Int. Cl. B41J 11/00; B41J 2/325; B41J 3/407; B41J 11/70; B41J 15/04

(52) U.S. Cl. CPC B41J 11/0095; B41J 2/325; B41J 3/4075; B41J 11/703; B41J 15/044

(57) ABSTRACT

A tape printing apparatus is configured to, in response to a detector outputting a first detection value, control a feed mechanism to feed the printing tape by a first distance in one of a first feed direction and a second feed direction, and to, depending on whether a post-feed output, which is an output of the detector after the printing tape is fed by the first distance, is the first detection value, perform an output determination for determining whether the first detection value output before the printing tape is fed by the first distance is an output due to a detection target portion being located at the detection position.

The present application is based on, and claims priority from JP Application Serial Number 2024-015070, filed Feb. 2, 2024, the disclosure of which is hereby incorporated by reference herein in its entirety.

### BACKGROUND

### 1. Technical Field

The present disclosure relates to a tape printing apparatus and a method for controlling the tape printing apparatus.

### 2. Related Art

As disclosed in JP-A-2018-069579, a known printing apparatus performs printing on labels while feeding a printing tape provided with a plurality of labels and notches corresponding to the respective labels. In this type of printing apparatus, the notches are detected by an optical sensor. For example, in a case where the optical sensor is a transmissive optical sensor, when the optical sensor outputs an optical transmission signal and detects the position of a notch, it is determined that the notch is located at the detection position of the optical sensor.

There are various kinds of printing tapes, one of which has light-transmitting areas other than the notches. In the case where such a special printing tape is used, even when a light-transmitting area is located at the detection position of the optical sensor, the optical sensor outputs an optical transmission signal, as is the case where a notch is located at the detection position. Therefore, in some cases, an existing printing apparatus recognizes a light-transmitting area as a notch by mistake, resulting in misalignment of the printing position.

### SUMMARY

According to an aspect of the present disclosure, a tape printing apparatus includes a feed mechanism configured to feed, in a first feed direction and in a second feed direction opposite to the first feed direction, a printing tape including a plurality of printing objects arranged in a length direction of the printing tape; a print head configured to perform printing on the printing objects of the printing tape being fed in the first feed direction; a detector configured to, when a detection position is located at a position shifted in the first feed direction from a printing position of the print head and a leading end of the printing tape is located at a position shifted in the second feed direction from the detection position and when one of a plurality of first areas of the printing tape is located at the detection position, output a first detection value, and to, when a second area other than the first areas of the printing tape is located at the detection position, output a second detection value; and a controller. The printing tape includes a plurality of detection target portions that are provided respectively for the printing objects and that function as the first areas. The controller is configured to, in response to the detector outputting the first detection value, control the feed mechanism to feed the printing tape by a first distance in one of the first feed direction and the second feed direction, and to, depending on whether a post-feed output is the first detection value, the post-feed output being an output of the detector after the printing tape is fed by the first distance, perform an output determination for determining whether the first detection value output before the printing tape is fed by the first distance is an output due to one of the detection target portions being located at the detection position.

According to another aspect of the present disclosure, a method for controlling a tape printing apparatus that includes a feed mechanism configured to feed, in a first feed direction and in a second feed direction opposite to the first feed direction, a printing tape including a plurality of printing objects arranged in a length direction of the printing tape, a print head configured to perform printing on the printing objects of the printing tape being fed in the first feed direction, and a detector configured to, when a detection position is located at a position shifted in the first feed direction from a printing position of the print head and a leading end of the printing tape is located at a position shifted in the second feed direction from the detection position and when one of a plurality of first areas of the printing tape is located at the detection position, output a first detection value, and to, when a second area other than the first areas of the printing tape is located at the detection position, output a second detection value. The printing tape includes a plurality of detection target portions that are provided respectively for the printing objects and that function as the first areas. The method, which is executed by the tape printing apparatus, includes, in response to the detector outputting the first detection value, controlling the feed mechanism to feed the printing tape by a first distance in one of the first feed direction and the second feed direction; and, depending on whether a post-feed output is the first detection value, the post-feed output being an output of the detector after the printing tape is fed by the first distance, determining whether the first detection value output before the printing tape is fed by the first distance is an output due to one of the detection target portions being located at the detection position.

### BRIEF DESCRIPTION OF THE DRAWINGS

FIG. 1 is an external view of a tape printing apparatus and a tape cartridge.

FIG. 2 illustrates arrangement of a print head, a sensor, and a cutter.

FIG. 3 illustrates an exemplary first printing tape.

FIG. 4 illustrates a state in which the leading end of the first printing tape is located at a cutting position.

FIG. 5 illustrates a state in which an end of a first detection target portion in the +X direction, disposed in the first printing tape, is located at a detection position.

FIG. 6 is a block diagram illustrating a hardware configuration of the tape printing apparatus.

FIG. 7 is a flowchart illustrating a first indexing process.

FIG. 8 is a flowchart illustrating a second indexing process.

FIG. 9 illustrates an exemplary second printing tape.

FIG. 10 illustrates a state in which the leading end of the second printing tape is located at a cutting position.

FIG. 11 illustrates a state in which an end of a second detection target portion in the +X direction in the second printing tape is located at a detection position.

FIG. 12 is a flowchart illustrating a third indexing process.

FIG. 13 illustrates a state in which the leading end of the second printing tape according to a first modification is located at a cutting position.

FIG. 14 is a flowchart illustrating a printing process according to the first modification.

FIG. 15 is a block diagram illustrating a hardware configuration of a tape printing apparatus according to a second modification.

FIG. 16 illustrates an exemplary table according to the second modification.

### DESCRIPTION OF EMBODIMENTS

Hereafter, a tape printing apparatus and a method for controlling the tape printing apparatus will be described with reference to the accompanying drawings. Regarding some of the drawings, description will be given using directions based on an XYZ orthogonal coordinate system, but these directions are merely for convenience of description and do not limit the following embodiments in any way.

### First Embodiment

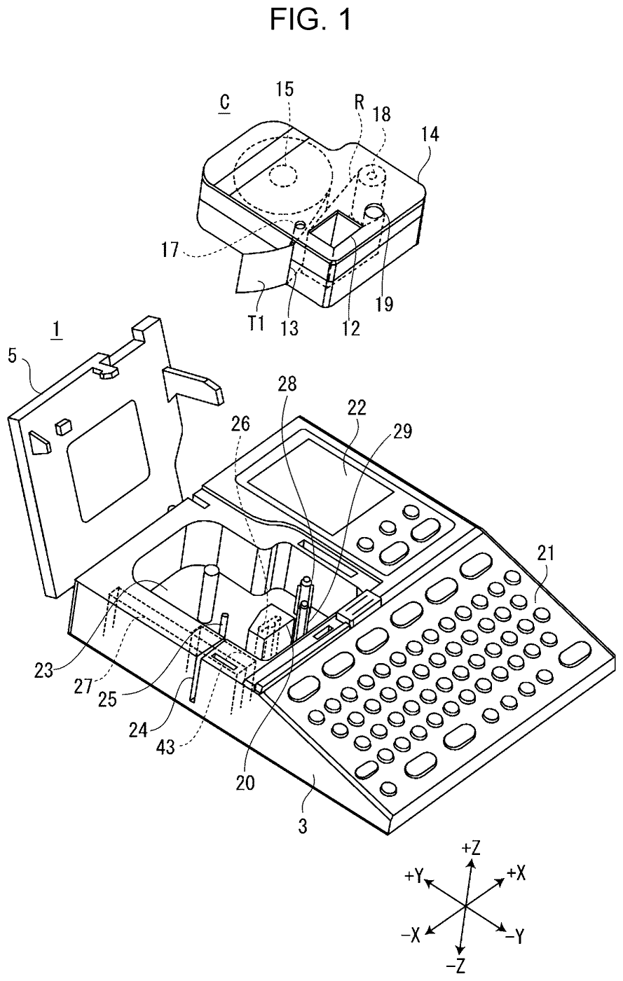

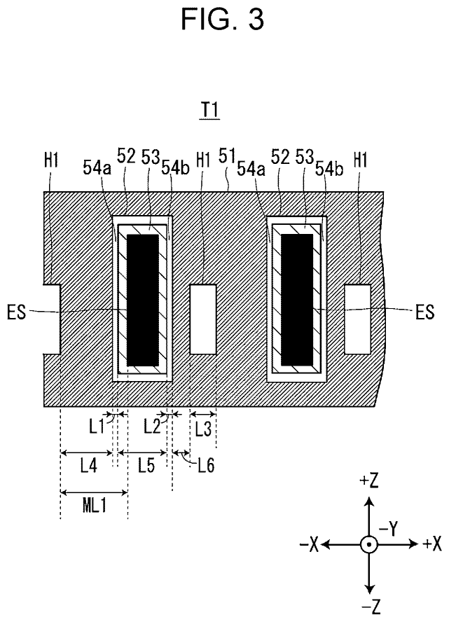

FIG. 1 is an external view of a tape printing apparatus 1 and a tape cartridge C. While feeding a printing tape T on which a plurality of printing objects are arranged along the tape length direction, the tape printing apparatus 1 performs printing on the printing objects. The printing object according to the present embodiment is a heat shrink tube 53 (hereafter referred to as an HST 53, refer to FIG. 3), which, when heated, shrinks to be tightly adhered onto an adhesion target object. The user covers an adhesion target object, such as a cable or a code, with the HST 53 on which printing was performed, and then applies heat to the HST 53 using a dryer or other heat means, thereby tightly adhering the HST 53 onto the adhesion target object. The printing tape T on which a plurality of HSTs 53 are arranged will be referred to as a first printing tape T1 hereafter.

The tape printing apparatus 1 includes a device case 3 and a mounting portion cover 5. An operation key group 21, a display 22, and a cartridge mounting portion 23 are provided on a surface of the device case 3 in a +Z direction.

The operation key group 21 receives various operations of the user, such as an editing operation on a print image to be printed on the HST 53 of the first printing tape T1. The display 22 displays various types of information, such as an editing screen for editing an image to be printed. The tape printing apparatus 1 generates print data based on the user's editing operation on the print image, and performs a printing process based on the generated print data.

The cartridge mounting portion 23 is a recess that is open in the +Z direction. A tape cartridge C is detachably mounted in the cartridge mounting portion 23. The mounting portion cover 5 is rotatably attached to an end portion of the device case 3 in a +Y direction, and opens and closes the cartridge mounting portion 23.

The tape cartridge C includes a tape core 15, a platen roller 17, a paying-out core 18, a winding core 19, and a cartridge case 11 that houses these components.

A first printing tape T1 is wound around the tape core 15. An ink ribbon R is wound around the paying-out core 18. The ink ribbon R fed out from the paying-out core 18 is then wound around the winding core 19. The cartridge case 11 includes a head insertion hole 12 extending through the cartridge case 11 in the Z-axis direction. Additionally, a tape outlet port 13 extending in the Z-axis direction is provided on a surface of the cartridge case 11 in the −X direction. The first printing tape T1 fed out from the tape core 15 is fed out of the cartridge case 11 through the tape outlet port 13.

In the cartridge mounting portion 23, a print head 26 and a head cover 20 are provided. The print head 26 performs printing on the HST 53 of the first printing tape T1. The head cover 20 partially covers the print head 26.

A platen drive shaft 25, a paying-out shaft 28, and a winding shaft 29 protrude in the +Z direction from the bottom surface of the cartridge mounting portion 23. When the tape cartridge C is mounted in the cartridge mounting portion 23, the platen drive shaft 25, the paying-out shaft 28, and the winding shaft 29 engage the platen roller 17, the paying-out core 18, and the winding core 19, respectively.

Additionally, when the tape cartridge C is mounted in the cartridge mounting portion 23, the print head 26 and the head cover 20 are inserted into a head insertion hole 12. Subsequently, when the mounting portion cover 5 is closed, the print head 26 is moved toward the platen roller 17 by a head moving mechanism (not illustrated). As a result, the print head 26 and the platen roller 17 pinch the first printing tape T1 and the ink ribbon R.

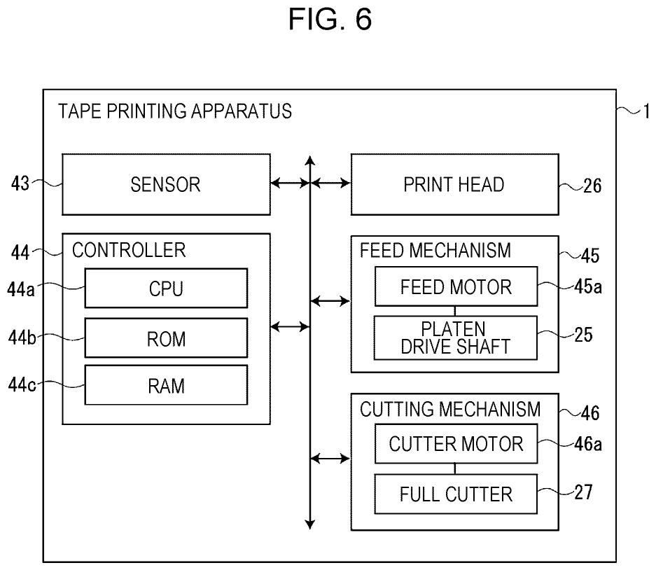

In this state, when a feed motor 45a included in the tape printing apparatus 1, as illustrated in FIG. 6, rotates in a first rotation direction, the platen roller 17 and the winding core 19 rotate. This causes the first printing tape T1 to be fed out from the cartridge case 11 through the tape outlet port 13 while the ink ribbon R is wound around the winding core 19. During this process, the first printing tape T1 is fed in the −X direction toward a tape outlet 24. The −X direction is an example of a first feed direction. Additionally, when the motor rotates in a second rotation direction opposite to the first rotation direction, the platen roller 17 and the paying-out core 18 rotate. This causes the first printing tape T1 to be pulled back into the cartridge case 11 while the ink ribbon R is wound back around the paying-out core 18. During this process, the first printing tape T1 is fed in the +X direction. The +X direction is an example of a second feed direction.

The print head 26 generates heat in accordance with print data when the first printing tape T1 is fed in the −X direction. As a result, the ink of the ink ribbon R is transferred to the HST 53 of the first printing tape T1, and a print image based on the print data is printed on the HST 53. The first printing tape T1 on which printing was performed exits from the tape outlet 24.

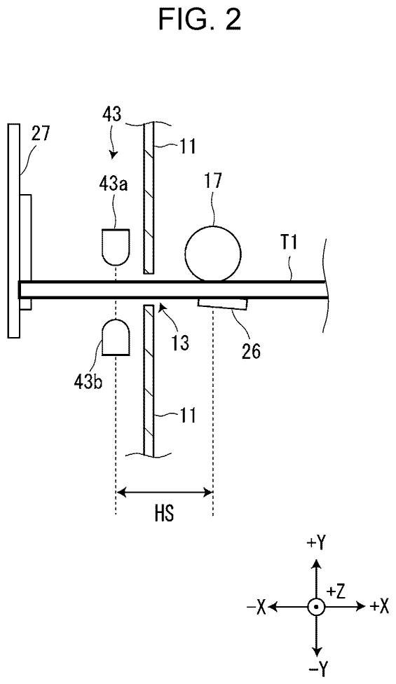

As illustrated in FIG. 2, a sensor 43 and a full cutter 27 are provided between the cartridge mounting portion 23 and the tape outlet 24. The sensor 43 is an example of a detector. The sensor 43 detects a first detection target portion H1 in the first printing tape T1 illustrated in FIG. 3. The first detection target portion H1 is an example of a detection target portion. During the printing process, the tape printing apparatus 1 detects the first detection target portion H1 and, based on a result of the detection, performs an indexing operation for printing on the HST 53. The full cutter 27 cuts the first printing tape T1 in the Z-axis direction, that is, in the tape width direction. As a result, the printed portion of the first printing tape T1 is cut off.

FIG. 2 illustrates arrangement of the print head 26, the sensor 43, and the full cutter 27. FIG. 2 illustrates an arrangement of members while the tape cartridge C is mounted in the cartridge mounting portion 23. Therefore, the platen roller 17, housed in the cartridge case 11 of the tape cartridge C, is located to face the print head 26 across the first printing tape T1.

As illustrated in FIG. 2, the detection position of the sensor 43 is located in the −X direction from the printing position of the print head 26. In the following description, the distance between the detection position of the sensor 43 and the printing position of the print head 26 in the X-axis direction is referred to as a sensor-to-head distance HS.

The sensor 43 is a transmissive optical sensor and includes a light emitting portion 43a and a light receiving portion 43b, which is disposed to face the light emitting portion 43a across the first printing tape T1. The sensor 43 outputs an ON signal when the light receiving portion 43b is in a light receiving state. The ON signal is an example of a first detection value. Additionally, the sensor 43 outputs an OFF signal when the light receiving portion 43b is not in the light receiving state. The OFF signal is an example of a second detection value. The sensor 43 outputs the ON signal when the leading end of the first printing tape T1 is located at a position shifted in the +X direction from the detection position and when a first area of the first printing tape T1 is located at the detection position. The first detection target portion H1 is included in the first area. Additionally, the sensor 43 outputs the OFF signal when a second area, which is an area other than the first area of the first printing tape T1, is located at the detection position. The second area includes the HST 53.

FIG. 3 illustrates an example of the first printing tape T1. The first printing tape T1 includes a mount tape 51 and a plurality of HSTs 53 arranged at equal intervals on the mount tape 51. The plurality of HSTs 53 have the same shape and size and are arranged along the length of the first printing tape T1. As mentioned above, when the tape cartridge C is mounted in the cartridge mounting portion 23, the length direction of the first printing tape T1 fed out from the tape cartridge C is the X-axis direction. The first printing tape T1 will be described hereafter using the direction when the tape cartridge C is mounted in the cartridge mounting portion 23.

The mount tape 51 consists of a light-transmitting adhesive layer and a non-light-transmitting mount layer that are stacked in order from the +Y direction. The surface of the adhesive layer in the −Y direction is an adhesive surface via which the adhesive layer is attached to the surface of the mount layer in the +Y direction. In the mount tape 51, a cutout region 52 is formed by cutting out a rectangular shape from the mount layer, and the first detection target portion H1 is formed by cutting out a rectangular shape slightly smaller than the cutout region 52 from the mount layer. In such a manner, the cutout region 52 and the first detection target portion H1 are regions where the mount layer of the mount tape 51 is removed, and therefore are light-transmitting. In contrast, the HST 53 is non-light-transmitting and is attached onto the adhesive surface of the light-transmitting adhesive layer in the cutout region 52. Therefore, in the cutout region 52, areas other than the attachment area of the HST 53 are light-transmitting. In the example of the first printing tape T1 illustrated in FIG. 3, light-transmitting areas are formed in the −X direction, in the +X direction, in the −Z direction, and in the +Z direction of the attachment area of the HST 53 in the cutout region 52.

Hereafter, a light-transmitting area from an end of the cutout region 52 in the −X direction to an end of the HST 53 in the −X direction will be referred to as a first light-transmitting area 54a. Additionally, a light-transmitting area from an end of the HST 53 in the +X direction to an end of the cutout region 52 in the +X direction will be referred to as a second light-transmitting area 54b.

In FIG. 3, a black region on the HST 53 indicates a printing target region ES. The printing target region ES refers to a region in which the print head 26 performs printing. The printing target region ES is a rectangular region surrounding a print image to be printed on the HST 53.

In the following description, the length of the first light-transmitting area 54a in the X-axis direction is referred to as a first length L1. Additionally, the length of the second light-transmitting area 54b in the X-axis direction is referred to as a second length L2. Additionally, the length of the first detection target portion H1 in the X-axis direction is referred to as a third length L3. In the X-axis direction, the first length L1 and the second length L2 are shorter than the third length L3.

Additionally, the length in the X-axis direction from an end of the first detection target portion H1 in the +X direction to an end of the first light-transmitting area 54a, which is located in the +X direction from the first detection target portion H1, in the −X direction is referred to as a fourth length L4. Additionally, the length in the X-axis direction from an end of the first light-transmitting area 54a in the +X direction to an end of the second light-transmitting area 54b in the −X direction, that is, the length of the HST 53 in the X-axis direction is referred to as a fifth length L5. Additionally, the length in the X-axis direction from an end of the second light-transmitting area 54b in the +X direction to an end of the first detection target portion H1, which is located in the +X direction from the second light-transmitting area 54b, in the −X direction is referred to as a sixth length L6.

Additionally, the length in the X-axis direction from the end of the first detection target portion H1 in the +X direction to an end of the printing target region ES in the −X direction is referred to as a first printing start length ML1. The first printing start length ML1 is a length calculated based on the print data. The end of the printing target region ES in the −X direction is a printing start position of the HST 53.

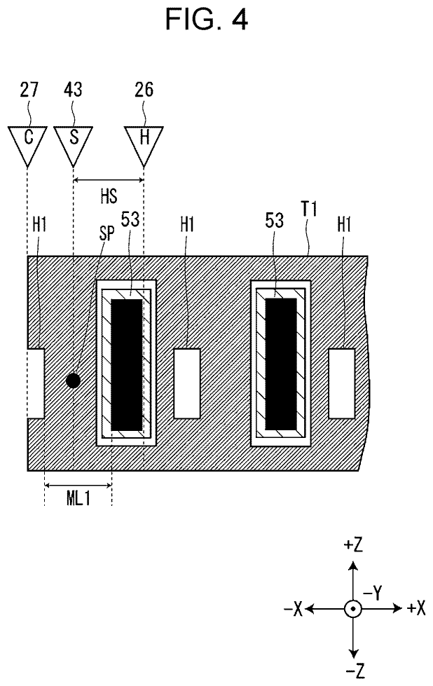

FIG. 4 illustrates a state in which the leading end of the first printing tape T1 is located at a cutting position of the full cutter 27. After completion of printing, the tape printing apparatus 1 cuts the first printing tape T1 while the first detection target portion H1 is located at the cutting position of the full cutter 27. Therefore, at the start of the printing process, the first printing tape T1 is normally in the state illustrated in FIG. 4.

However, in some use cases of the tape cartridge C, the leading end of the first printing tape T1 may not be located at the cutting position of the full cutter 27 at the start of the printing process. For example, when the user removes the tape cartridge C from the cartridge mounting portion 23 and cuts the first printing tape T1 with scissors in a vicinity of the tape outlet port 13 of the cartridge case 11, the leading end of the first printing tape T1 is located at a position shifted in the +X direction from the detection position. Additionally, when the user intentionally pulls out the tape cartridge C after removing the tape cartridge C, the leading end of the first printing tape T1 is located at a position shifted in the −X direction from the detection position.

In such a manner, the leading end of the first printing tape T1 is not always located at the cutting position of the full cutter 27. Therefore, after the start of the printing process, the tape printing apparatus 1 feeds the first printing tape T1 in the +X direction to detect the first detection target portion H1. The details will be described later.

As illustrated in FIG. 4, the detection position of the sensor 43 in the Z-axis direction is located substantially at the center of the first printing tape T1. This position corresponds to the position of the first detection target portion T1, disposed in the first printing tape H1, in the Z-axis direction.

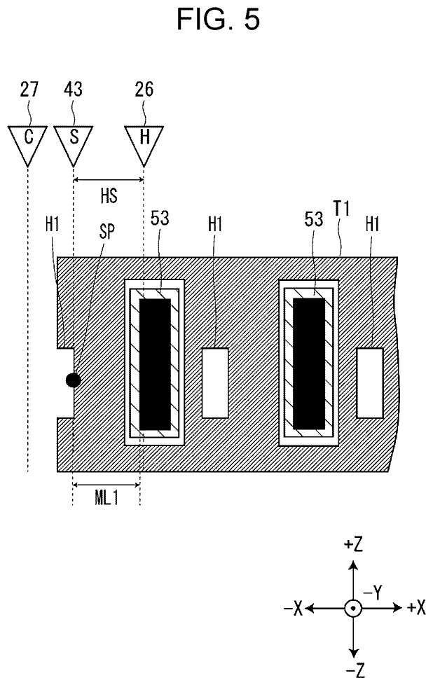

FIG. 5 illustrates a state in which the end of the first detection target portion H1, disposed in the first printing tape T1, in the +X direction is located at the detection position of the sensor 43. The tape printing apparatus 1 detects the end of the first detection target portion H1 in the +X direction and, based on a result of the detection, performs an indexing operation to align the printing start position of the HST 53 with the printing position of the print head 26.

With reference to FIG. 6, the hardware configuration of the tape printing apparatus 1 will be described. The tape printing apparatus 1 includes the sensor 43, a controller 44, a print head 26, a feed mechanism 45, and a cutting mechanism 46.

The sensor 43 is a transmissive optical sensor as mentioned above. The sensor 43 outputs the ON signal when the first area that is light-transmitting, such as the first detection target portion H1 of the first printing tape T1, is located at a detection position, and outputs the OFF signal when the second area that is non-light-transmitting is located at the detection position.

The controller 44 includes a central processing unit (CPU) 44a, a read-only memory (ROM) 44b, and a random access memory (RAM) 44c.

The CPU 44a performs various kinds of control by loading a control program such as firmware stored in the ROM 44b into the RAM 44c and executing the control program. The controller 44 may use a hardware circuit such as an ASIC, instead of the CPU 44a, as a processor. Additionally, the processor may have a configuration in which one or more CPUs and a hardware circuit, such as an ASIC, operate in cooperation with each other.

The print head 26 includes a group of heating elements and performs printing by thermally transferring ink from the ink ribbon R to the HST 53 of the first printing tape T1.

The feed mechanism 45 includes the feed motor 45a and the platen drive shaft 25. The feed motor 45a is a drive source that drives the platen drive shaft 25. In the present embodiment, the feed motor 45a is a stepper motor. The CPU44a controls the feeding amount of the printing tape T based on the number of steps for rotating the feed motor 45a.

The cutting mechanism 46 includes a cutter motor 46a and the full cutter 27. The cutter motor 46a is a drive source that drives the full cutter 27. When the cutter motor 46a is driven, the full cutter 27 is operated to cut the printing tape T in the Z-axis direction.

The main functions of the controller 44 will be described here. After a printing start instruction is obtained, the controller 44 controls the feed mechanism 45 to feed the first printing tape T1 in the +X direction. Then, when the ON signal is output by the sensor 43, the controller 44 controls the feed mechanism 45 to feed the first printing tape T1 in the +X direction by a first determination distance. The first determination distance is an example of a first distance. In the present embodiment, the first determination distance is longer in the X-axis direction than the length of any one of one or more light-transmitting areas 54 present between the first detection target portions H1. As illustrated in FIG. 3, in the present embodiment, two light-transmitting areas 54 are present, which are the first light-transmitting area 54a having the first length L1 in the X-axis direction and the second light-transmitting area 54b having the second length L2 in the X-axis direction. Therefore, the first determination distance is longer than the length of one of the first length L1 and the second length L2. Additionally, the first determination distance is shorter than the third length L3, which is the length of the first detection target portion H1 in the X-axis direction. Additionally, the first determination distance is shorter in the X-axis direction than a length between the first areas. That is, in the present embodiment, the first determination distance is shorter than any one of the fourth length L4, the fifth length L5, and the sixth length L6.

When a post-feed output, which is an output of the sensor 43 after the first printing tape T1 is fed by the first determination distance, is the ON signal, the controller 44 determines that the ON signal output before the first printing tape T1 is fed by the first determination distance is an output due to the first detection target portion H1 being located at the detection position. Additionally, when the post-feed output is not the ON signal, the controller 44 determines that the ON signal output before the first printing tape T1 is fed by the first determination distance is not an output due to the first detection target portion H1 being located at the detection position. This is because the first determination distance is set to be shorter than the third length L3, which is the length of the first detection target portion H1, and to be longer than either of the first length L1 and the second length L2, which are the lengths of the light-transmitting areas 54, in the X-axis direction.

Additionally, if it is determined in an output determination that the ON signal output before the first printing tape T1 is fed by the first determination distance is an output due to the first detection target portion H1 being located at the detection position, the controller 44 controls the feed mechanism 45 to perform an indexing operation to align the printing start position of the HST 53 with the printing position of the print head 26. The process of performing an indexing operation of the HST 53 located farthest in the −X direction among a plurality of HSTs 53 arranged on the first printing tape T1 will be referred to as a first indexing process hereafter. Additionally, the HST 53 located farthest in the −X direction among the plurality of HSTs 53 arranged on the first printing tape T1 will be referred to as a first HST 53. Additionally, the HST 53 located next to the first HST 53 in the +X direction will be referred to as a second HST 53.

Additionally, after performing an indexing operation of the first HST 53, the controller 44 controls the feed mechanism 45 to feed the first printing tape T1 in the −X direction. Then, when the ON signal is output by the sensor 43, the controller 44 controls the feed mechanism 45 to feed the first printing tape T1 in the −X direction by the first determination distance. The output determination is the same as described above. If it is determined in the output determination that the ON signal output before the first printing tape T1 is fed by the first determination distance is an output due to the first detection target portion H1 being located at the detection position, the controller 44 controls the feed mechanism 45 to perform an indexing operation to align the printing start position of the second or subsequent HST 53 with the printing position of the print head 26. The process of performing an indexing operation of the second or subsequent HST 53 will be referred to as a second indexing process hereafter.

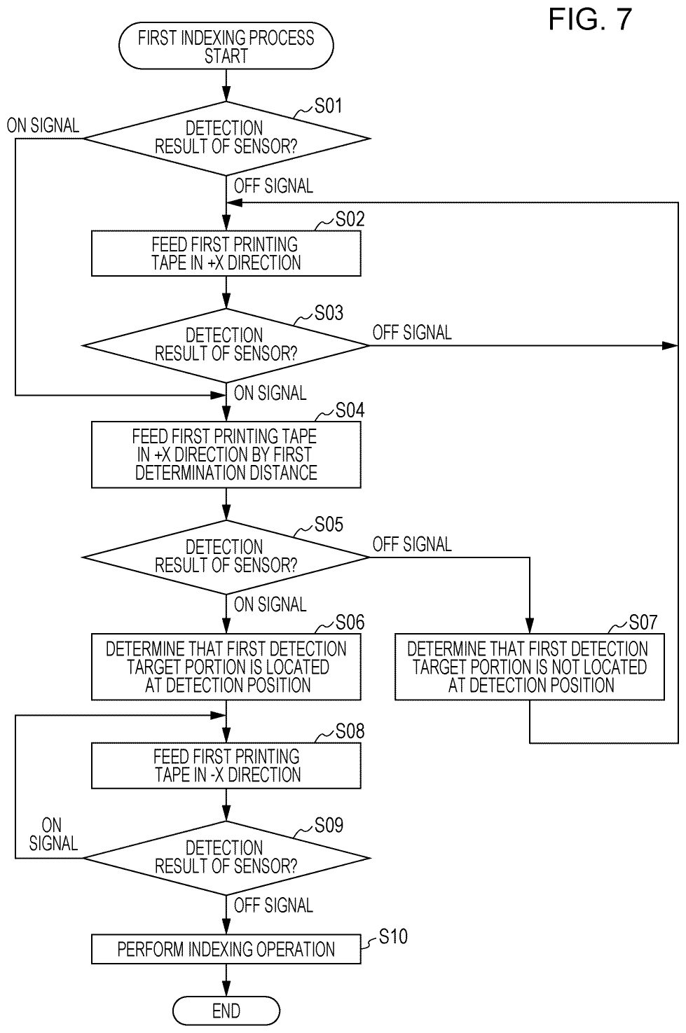

With reference to the flowchart in FIG. 7, the flow of the first indexing process performed by the tape printing apparatus 1 will now be described. The first indexing process is an example of a method for controlling a tape printing apparatus. Additionally, the first indexing process is a process that starts when the tape printing apparatus 1 obtains a printing start instruction. When the printing start instruction is obtained, the tape printing apparatus 1 generates print data based on a result of the user's editing on a print image and then starts the first indexing process.

At step S01, the tape printing apparatus 1 determines a detection result of the sensor 43. If it is determined that the detection result of the sensor 43 is the OFF signal, the tape printing apparatus 1 proceeds to step S02. Additionally, if it is determined that the detection result of the sensor 43 is the ON signal, the tape printing apparatus 1 proceeds to step S04.

At step S02, the tape printing apparatus 1 feeds the first printing tape T1 in the +X direction.

At step S03, the tape printing apparatus 1 determines a detection result of the sensor 43. If it is determined that the detection result of the sensor 43 is the ON signal, the tape printing apparatus 1 proceeds to step S04. Additionally, if it is determined that the detection result of the sensor 43 is the OFF signal, the tape printing apparatus 1 returns to step S02.

At step S04, the tape printing apparatus 1 feeds the first printing tape T1 in the +X direction by the first determination distance.

At step S05, the tape printing apparatus 1 determines a detection result of the sensor 43. If it is determined that the detection result of the sensor 43 is the ON signal, the tape printing apparatus 1 proceeds to step S06. Additionally, if it is determined that the detection result of the sensor 43 is the OFF signal, the tape printing apparatus 1 proceeds to step S07.

At step S06, the tape printing apparatus 1 determines that the first detection target portion H1 is located at the detection position of the sensor 43. That is, when it is determined at step S01 that the ON signal is detected, the tape printing apparatus 1 determines that, at that time, the first detection target portion H1 is located at the detection position of the sensor 43. Additionally, when it is determined at step S03 that the ON signal is detected, the tape printing apparatus 1 determines that, at that time, an end of the first detection target portion H1 in the +X direction is located at the detection position of the sensor 43.

At step S07, the tape printing apparatus 1 determines that the first detection target portion H1 is not located at the detection position of the sensor 43. That is, when it is determined at step S01 that the ON signal is detected, the tape printing apparatus 1 determines that, at that time, the first light-transmitting area 54a or the second light-transmitting area 54b is located at the detection position of the sensor 43. Additionally, when it is determined at step S03 that the ON signal is detected, the tape printing apparatus 1 determines that, at that time, an end of the first light-transmitting area 54a or the second light-transmitting area 54b in the +X direction is located at the detection position of the sensor 43. After step S07, the tape printing apparatus 1 returns to step S02. The determinations at steps S06 and S07 are examples of the output determination.

At step S08, the tape printing apparatus 1 feeds the first printing tape T1 in the −X direction.

At step S09, the tape printing apparatus 1 determines a detection result of the sensor 43. If it is determined that the detection result of the sensor 43 is the OFF signal, the tape printing apparatus 1 proceeds to step S10. In this case, the tape printing apparatus 1 determines that the end of the first detection target portion H1 in the +X direction is detected. Additionally, if it is determined that the detection result of the sensor 43 is the ON signal, the tape printing apparatus 1 returns to step S08. When the rotation direction of the feed motor 45a is switched, non-printing feed control of the feed motor 45a is performed in order to reduce the effects of backlash of a gear train mechanism (not illustrated) included in the feed mechanism 45. At this occasion, steps S08 and S09 may be omitted.

At step S10, the tape printing apparatus 1 performs an indexing operation. When the first printing start length ML1 is longer than the sensor-to-head distance HS, after it is determined at step S09 that the detection result of the sensor 43 is the OFF signal, the tape printing apparatus 1 performs an indexing operation by feeding the first printing tape T1 in the −X direction by a length obtained by subtracting the sensor-to-head distance HS from the first printing start length ML1. In contrast, when the first printing start length ML1 is shorter than the sensor-to-head distance HS, after it is determined at step S09 that the detection result of the sensor 43 is the OFF signal, the tape printing apparatus 1 performs an indexing operation by feeding the first printing tape T1 in the +X direction by a length obtained by subtracting the first printing start length ML1 from the sensor-to-head distance HS.

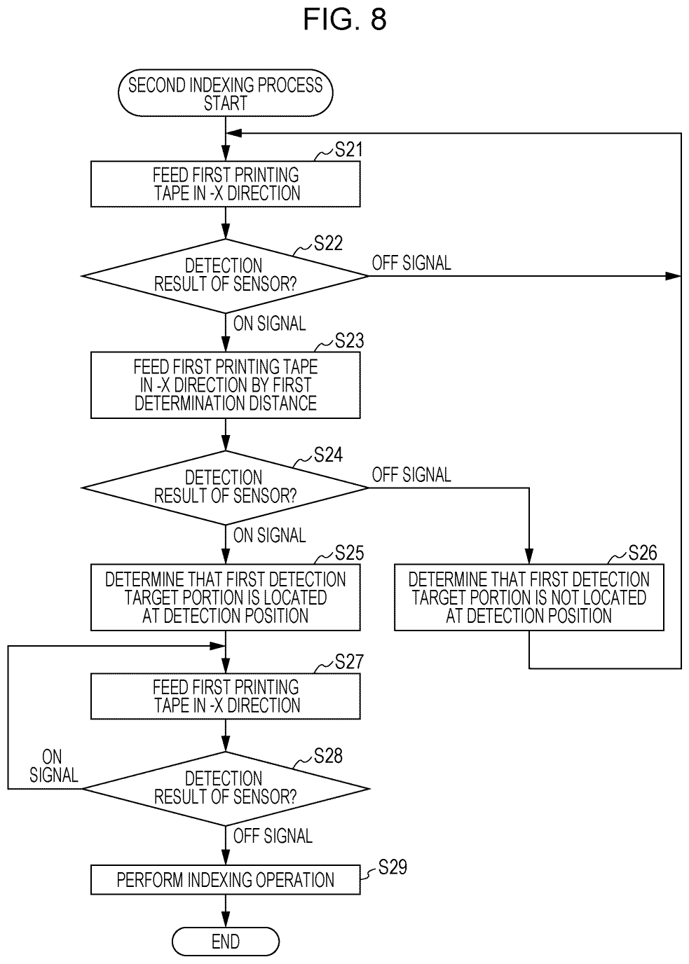

With reference to the flowchart in FIG. 8, the flow of the second indexing process performed by the tape printing apparatus 1 will now be described. The second indexing process is an example of the method for controlling a tape printing apparatus. Additionally, the second indexing process is a process of performing an indexing operation of the second or subsequent HST 53, and starts after the first indexing process.

At step S21, the tape printing apparatus 1 feeds the first printing tape T1 in the −X direction.

At step S22, the tape printing apparatus 1 determines a detection result of the sensor 43. If it is determined that the detection result of the sensor 43 is the ON signal, the tape printing apparatus 1 proceeds to step S23. Additionally, if it is determined that the detection result of the sensor 43 is the OFF signal, the tape printing apparatus returns to step S21.

At step S23, the tape printing apparatus 1 feeds the first printing tape T1 in the −X direction by the first determination distance.

At step S24, the tape printing apparatus 1 determines a detection result of the sensor 43. If it is determined that the detection result of the sensor 43 is the ON signal, the tape printing apparatus 1 proceeds to step S25. Additionally, if it is determined that the detection result of the sensor 43 is the OFF signal, the tape printing apparatus 1 proceeds to step S26.

At step S25, the tape printing apparatus 1 determines that the first detection target portion H1 is located at the detection position of the sensor 43. That is, the tape printing apparatus 1 determines that, at the time when it is determined at step S22 that the detection result of the sensor 43 is the ON signal, the end of the first detection target portion H1 in the −X direction is located at the detection position of the sensor 43.

At step S26, the tape printing apparatus 1 determines that the first detection target portion H1 is not located at the detection position of the sensor 43. That is, the tape printing apparatus 1 determines that, at the time when it is determined at step S22 that the detection result of the sensor 43 is the ON signal, the end of the first light-transmitting area 54a or the second light-transmitting area 54b in the −X direction is located. After step S26, the tape printing apparatus 1 returns to step S21. The determinations at steps S25 and S26 are examples of the output determination.

At step S27, the tape printing apparatus 1 feeds the first printing tape T1 in the −X direction.

At step S28, the tape printing apparatus 1 determines a detection result of the sensor 43. If it is determined that the detection result of the sensor 43 is the OFF signal, the tape printing apparatus 1 proceeds to step S29. In this case, the tape printing apparatus 1 determines that the end of the first detection target portion H1 in the +X direction is detected. Additionally, if it is determined that the detection result of the sensor 43 is the ON signal, the tape printing apparatus 1 returns to step S27.

At step S29, the tape printing apparatus 1 performs an indexing operation. The tape printing apparatus 1 performs different indexing operations depending on whether a margin length ML is longer than the sensor-to-head distance HS. For example, it is assumed that the first detection target portions H1 are arranged in the first printing tape T1 in the order of the nth first detection target portion H1, the (n+1)th first detection target portion H1, and the (n+2)th first detection target portion H1 from the −X direction. In this situation, the nth HST 53 is disposed between the nth first detection target portion H1 and the (n+1)th first detection target portion H1, and the (n+1)th HST 53 is disposed between the (n+1)th first detection target portion H1 and the (n+2)th first detection target portion H1. In this case, when the margin length ML is longer than the sensor-to-head distance HS, the tape printing apparatus 1 performs an indexing operation of the nth HST 53 based on a detection result of the nth first detection target portion H1; however, when the margin length ML is shorter than the sensor-to-head distance HS, the tape printing apparatus 1 performs an indexing operation of the (n+1)th HST 53 based on a detection result of the nth first detection target portion H1.

As described above, when the ON signal is output by the sensor 43, the tape printing apparatus 1 according to the first embodiment feeds the first printing tape T1 by the first determination distance in one direction of the −X direction and the +X direction. The first determination distance is longer than any one of the first length L1 and the second length L2, and is shorter than any one of the third length L3, the fourth length L4, the fifth length L5, and the sixth length L6. Then, when the sensor 43 outputs the ON signal after the first printing tape T1 is fed by the first determination distance, the tape printing apparatus 1 determines that the ON signal output before the first printing tape T1 is fed by the first determination distance is an output due to the first detection target portion H1 being located at the detection position of the sensor 43. Additionally, when the sensor 43 outputs the OFF signal after the first printing tape T1 is fed by the first determination distance, the tape printing apparatus 1 determines that the ON signal output before the first printing tape T1 is fed by the first determination distance is not an output due to the first detection target portion H1 being located at the detection position of the sensor 43. As a result, even with the use of the first printing tape T1 including the light-transmitting areas 54, the tape printing apparatus 1 may accurately detect the first detection target portion H1, leading to a reduction in the deviation of the printing position due to incorrect detection of the first detection target portion H1.

Additionally, in the first indexing process, the tape printing apparatus 1 obtains a printing start instruction and then feeds the first printing tape T1 in the +X direction to perform an output determination, and therefore the HSTs 53 are not wasted.

### Second Embodiment

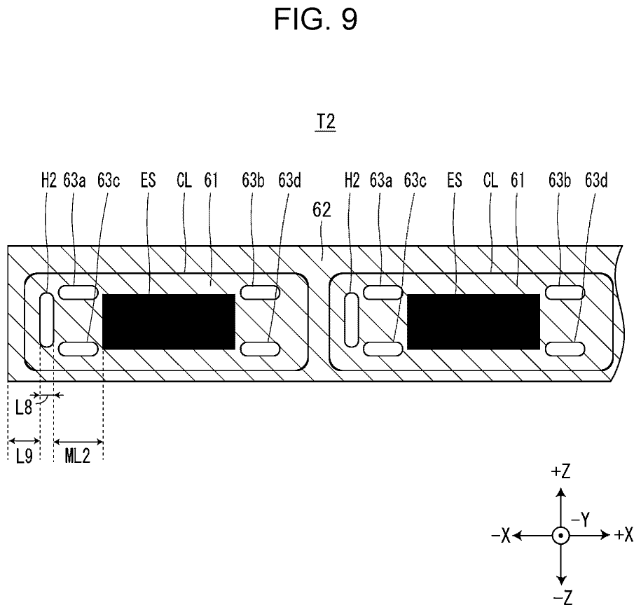

With reference to FIGS. 9 to 12, a second embodiment will be described. Although the first printing tape T1 is used as the printing tape T in the first embodiment, a second printing tape T2 illustrated in FIG. 9 is used, instead of the first printing tape T1, in the present embodiment. The second printing tape T2 has a feature in that a detection target portion H is formed in the printing object. Hereafter, only points different from those of the first embodiment will be described. In the present embodiment, the same components as in the first embodiment are denoted by the same reference numerals, and detailed description thereof will be omitted. Additionally, modifications applied to the same components as in the first embodiment are similarly applied to the present embodiment.

FIG. 9 illustrates an example of the second printing tape T2. The second printing tape T2 is divided into a plate 61, which is an area inside a cut CL, and a peripheral portion 62, which is an area outside the cut CL, by the cut CL. The plate 61 is an example of a printing object. The second printing tape T2 is formed of a thin resin.

In the second printing tape T2, a plurality of plates 61 having the same shape and size are arranged at equal intervals in the X-axis direction. In an end of the plate 61 in the −X direction, a second detection target portion H2 is formed. The second detection target portion H2 is a rounded rectangular through hole that is long in the Z-axis direction. Additionally, a first hole 63a, a second hole 63b, a third hole 63c, and a fourth hole 63d are formed near the four corners of the plate 61, respectively. These four holes 63 are rounded rectangular through holes that are long in the X-axis direction. The area of the second printing tape T2 other than the second detection target portions H2 and the four holes 63 are non-light-transmitting. Additionally, in FIG. 9, black regions on the plate 61 indicate printing target regions ES.

When printing on the plate 61 finishes, the user bends a portion of the cut CL to raise an end of the plate 61 up from the peripheral portion 62, and picks up the raised end of the plate 61, thereby separating the plate 61 from the peripheral portion 62. The user passes a cable tie or a string through at least one of the second detection target portion H2 and the four holes 63 of the separated plate 61. Then, the user fixes the plate 61 to the adhesion target object, such as a cable or a code, using a cable tie or a string suitable for the holes 63.

The length of the second detection target portion H2 in the X-axis direction is referred to as an eighth length L8. Additionally, the length in the X-axis direction from the leading end of the second printing tape T2, which is an end of the second printing tape T2 in the −X direction, to the end in the −X direction of the second detection target portion H2, which is disposed in the plate 61 located farthest in the −X direction among the plurality of plates 61 arranged on the second printing tape T2, that is, the first plate 61, is referred to as a ninth length L9. Additionally, the length in the X-axis direction from an end of the second detection target portion H2 in the +X direction to the end of the printing target region ES in the −X direction is referred to as a second printing start length ML2. The second printing start length ML2 is a length calculated based on print data.

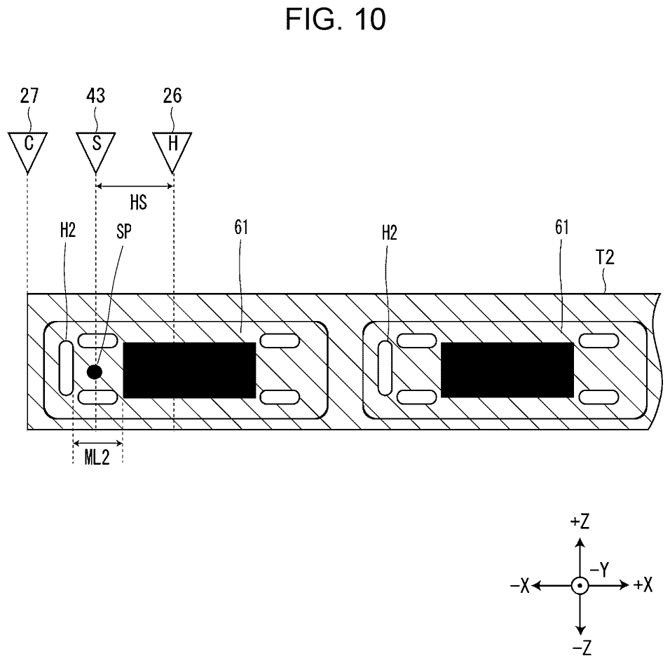

FIG. 10 illustrates a state in which the leading end of the second printing tape T2 is located at a cutting position of the full cutter 27. After completion of printing, the tape printing apparatus 1 cuts the second printing tape T2 while the peripheral portion 62 between the plates 61 is located at the cutting position of the full cutter 27. Therefore, at the start of the printing process, the second printing tape T2 is normally in a state illustrated in FIG. 10.

However, in some use cases of the tape cartridge C, the leading end of the second printing tape T2 may not be located at the cutting position of the full cutter 27 at the start of the printing process. In other words, the second detection target portion H2 is not necessarily located in the −X direction from the detection position of the sensor 43 at the start of the printing process. For example, in the case where some point between the leading end of the second printing tape T2 and the second detection target portion H2 is located at the detection position of the sensor 43 at the start of the printing process, when the tape printing apparatus 1 feeds the second printing tape T2 in the +X direction after the start of the printing process, the ON signal is output for the first time by the sensor 43 at the time point at which the leading end of the second printing tape T2 passes through the detection position. In such a case, in order to avoid incorrect detection in which output of the ON signal is caused by detection of the second detection target portion H2, at the start of the printing process, the tape printing apparatus 1 performs an output determination of whether output of the ON signal is caused by detection of the second detection target portion H2. As illustrated in FIG. 10, in the Z-axis direction, the detection position of the sensor 43 corresponds to the position of the second detection target portion H2 but does not correspond to the positions of the four holes 63. Therefore, none of the four holes 63 is incorrectly detected as the second detection target portion H2.

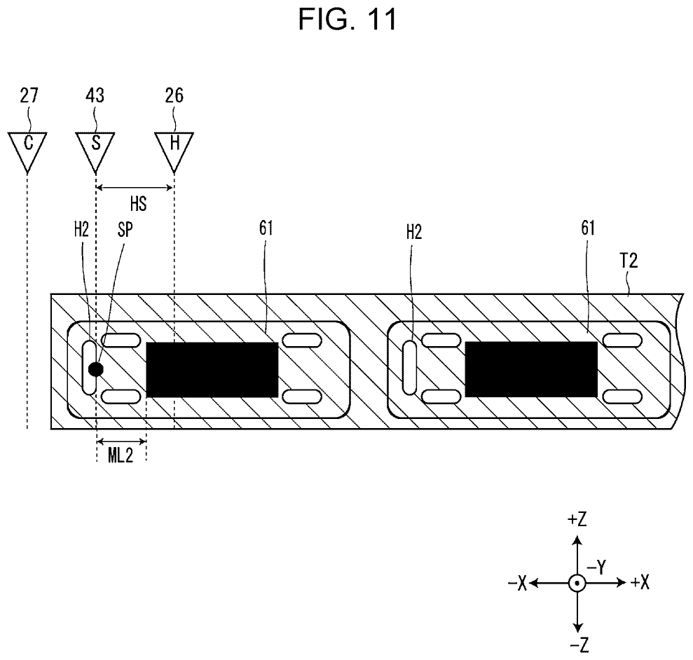

FIG. 11 illustrates a state in which the end of the second detection target portion H2 in the +X direction in the second printing tape T2 is located at the detection position of the sensor 43. The tape printing apparatus 1 detects the end of the second detection target portion H2 in the +X direction and, based on a result of the detection, performs an indexing operation to align the printing start position of the plate 61 with the printing position of the print head 26.

The main functions of the controller 44 according to the present embodiment will be described here. After obtaining a printing start instruction, the controller 44 controls the feed mechanism 45 to feed the second printing tape T2 in the +X direction. Then, when the ON signal is output by the sensor 43, the controller 44 controls the feed mechanism 45 to feed the second printing tape T2 in the +X direction by a second determination distance. The second determination distance is an example of the first distance. The second determination distance is a determination distance in a third indexing process described later. In the present embodiment, as illustrated in FIG. 9, the second determination distance is longer than the eighth length L8 and shorter than the ninth length L9.

When a post-feed output, which is an output of the sensor 43 after the second printing tape T2 is fed by the second determination distance, is not the ON signal, the controller 44 determines that the ON signal output before the second printing tape T2 is fed by the second determination distance is an output due to the second detection target portion H2 being located at the detection position. Additionally, when the post-feed output, which is an output of the sensor 43 after the second printing tape T2 is fed by the second determination distance, is the ON signal, the controller 44 determines that the ON signal output before the second printing tape T2 is fed by the second determination distance is not an output due to the second detection target portion H2 being located at the detection position. This is because the second determination distance is set to a length in the X-axis direction that is longer than the eighth length L8, which is the length of the second detection target portion H2 in the X-axis direction, and is shorter than the ninth length L9, which is the length from the leading end of the second printing tape T2 to the end of the second detection target portion H2, disposed in the first plate 61, in the −X direction.

If it is determined in the output determination that the ON signal output before the second printing tape T2 is fed by the second determination distance is an output due to the second detection target portion H2 being located at the detection position, the controller 44 controls the feed mechanism 45 to perform an indexing operation to align the printing start position of the plate 61 with the printing position of the print head 26.

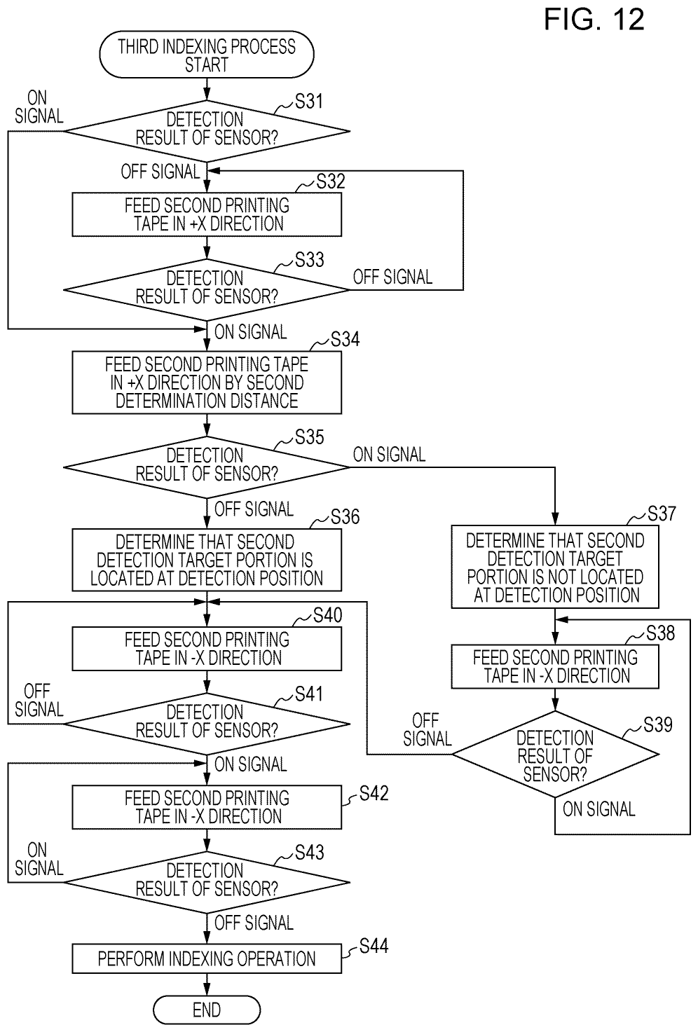

With reference to the flowchart in FIG. 12, the flow of the third indexing process, which is an indexing process of the tape printing apparatus 1 according to the present embodiment, will now be described. The third indexing process is an example of the method for controlling a tape printing apparatus. Additionally, the third indexing process is a process that starts when the tape printing apparatus 1 obtains a printing start instruction. When the printing start instruction is obtained, the tape printing apparatus 1 generates print data based on a result of the user's editing on a print image and then starts the third indexing process.

At step S31, the tape printing apparatus 1 determines a detection result of the sensor 43. If it is determined that the detection result of the sensor 43 is the OFF signal, the tape printing apparatus 1 proceeds to step S32. Additionally, if it is determined that the detection result of the sensor 43 is the ON signal, the tape printing apparatus 1 proceeds to step S34.

At step S32, the tape printing apparatus 1 feeds the second printing tape T2 in the +X direction.

At step S33, the tape printing apparatus 1 determines a detection result of the sensor 43. If it is determined that the detection result of the sensor 43 is the ON signal, the tape printing apparatus 1 proceeds to step S34. Additionally, if it is determined that the detection result of the sensor 43 is the OFF signal, the tape printing apparatus 1 returns to step S32.

At step S34, the tape printing apparatus 1 feeds the second printing tape T2 in the +X direction by the second determination distance.

At step S35, the tape printing apparatus 1 determines a detection result of the sensor 43. If it is determined that the detection result of the sensor 43 is the OFF signal, the tape printing apparatus 1 proceeds to step S36. Additionally, if it is determined that the detection result of the sensor 43 is the ON signal, the tape printing apparatus 1 proceeds to step S37.

At step S36, the tape printing apparatus 1 determines that the second detection target portion H2 is located at the detection position of the sensor 43. That is, if it is determined at step S31 that the ON signal is detected, the tape printing apparatus 1 determines that, at that time, the second detection target portion H2 is located at the detection position of the sensor 43. Additionally, if it is determined at step S33 that the ON signal is detected, it is determined at that time that the end of the second detection target portion H2 in the +X direction is located at the detection position of the sensor 43.

At step S37, the tape printing apparatus 1 determines that the second detection target portion H2 is not located at the detection position of the sensor 43. That is, if it is determined at step S31 that the ON signal is detected, the tape printing apparatus 1 determines that, at that time, the leading end of the second printing tape T2 is located at a position shifted in the +X direction from the detection position of the sensor 43. Additionally, if it is determined at step S33 that the ON signal is detected, the tape printing apparatus 1 determines that, at that time, the leading end of the second printing tape T2 is located at the detection position of the sensor 43. The determinations at steps S36 and S37 are examples of the output determination.

At step S38, the tape printing apparatus 1 feeds the second printing tape T2 in the −X direction.

At step S39, the tape printing apparatus 1 determines a detection result of the sensor 43. If it is determined that the detection result of the sensor 43 is the OFF signal, the tape printing apparatus 1 proceeds to step S40. In this case, the tape printing apparatus 1 determines that the leading end of the second printing tape T2 is detected. Additionally, if it is determined that the detection result of the sensor 43 is the ON signal, the tape printing apparatus 1 returns to step S38.

At step S40, the tape printing apparatus 1 feeds the second printing tape T2 in the −X direction.

At step S41, the tape printing apparatus 1 determines a detection result of the sensor 43. If it is determined that the detection result of the sensor 43 is the ON signal, the tape printing apparatus 1 proceeds to step S42. In this case, the tape printing apparatus 1 determines that the end of the second detection target portion H2 in the −X direction is detected. Additionally, if it is determined that the detection result of the sensor 43 is the OFF signal, the tape printing apparatus 1 returns to step S40.

At step S42, the tape printing apparatus 1 feeds the second printing tape T2 in the −X direction.

At step S43, the tape printing apparatus 1 determines a detection result of the sensor 43. If it is determined that the detection result of the sensor 43 is the OFF signal, the tape printing apparatus 1 proceeds to step S44. In this case, the tape printing apparatus 1 determines that the end of the second detection target portion H2 in the +X direction is detected. Additionally, if it is determined that the detection result of the sensor 43 is the ON signal, the tape printing apparatus 1 returns to step S42.

At step S44, the tape printing apparatus 1 performs an indexing operation. When the margin length ML is longer than the sensor-to-head distance HS, after it is determined at step S43 that the detection result of the sensor 43 is the OFF signal, the tape printing apparatus 1 performs an indexing operation by feeding the second printing tape T2 in the −X direction by a length obtained by subtracting the sensor-to-head distance HS from the margin length ML. In contrast, when the margin length ML is shorter than the sensor-to-head distance HS, after it is determined at step S43 that the detection result of the sensor 43 is the OFF signal, the tape printing apparatus 1 performs an indexing operation by feeding the second printing tape T2 in the +X direction by a length obtained by subtracting the margin length ML from the sensor-to-head distance HS.

After performing an indexing operation of the first plate 61, the tape printing apparatus 1 according to the present embodiment performs indexing operations of the second and subsequent plates 61 without performing the output determination. Additionally, when cutting the second printing tape T2 after performing printing on the plate 61, the tape printing apparatus 1 according to the present embodiment detects an end of the second detection target portion H2 in the +X direction, then feeds the second printing tape T2 by a predetermined length in the −X direction, and cuts the second printing tape T2. In this case, the predetermined length is a length obtained by subtracting the eighth length L8 and the ninth length L9 from the distance in the X-axis direction between the detection position of the sensor 43 and the cutting position of the full cutter 27.

As described above, the tape printing apparatus 1 according to the second embodiment may reduce the deviation of the printing position due to incorrect detection of the second detection target portion H2 even when the second printing tape T2 in which the second detection target portion H2 is formed on the plate 61 is used.

Not only the above two embodiments but also the following modifications may be adopted.

### First Modification

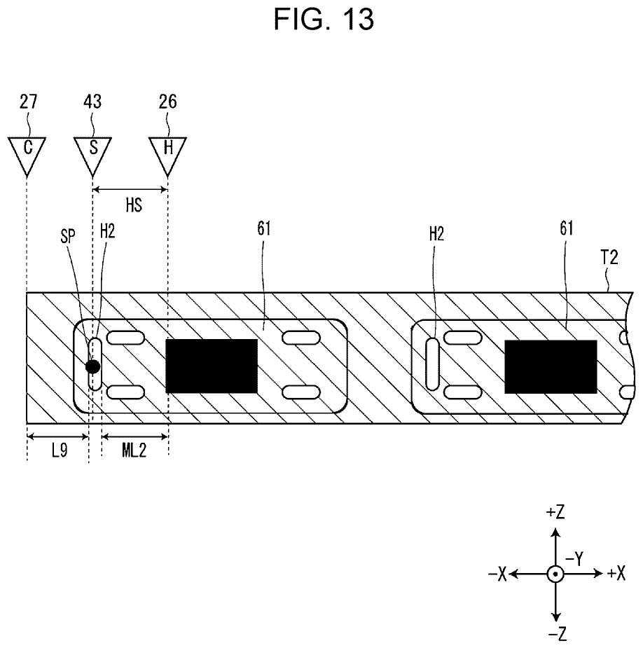

As a modification of the second embodiment, the second printing tape T2 illustrated in FIG. 13 may be used. FIG. 13 illustrates a state in which the leading end of the second printing tape T2 according to the present modification is located at the cutting position. In the second printing tape T2 according to the present modification, the interval between the plates 61 in the X-axis direction is wide and the ninth lengths L9 and the second printing start lengths ML2 are long, compared to the second printing tape T2 according to the second embodiment illustrated in FIG. 9. In the present modification, after detecting the end of the second detection target portion H2 in the −X direction, the tape printing apparatus 1 stops feeding the second printing tape T2 in the −X direction, and cuts the second printing tape T2. Therefore, when the second printing tape T2 is cut, the second printing tape T2 is normally in the state illustrated in FIG. 13. That is, when the second printing tape T2 is cut, the detection position of the sensor 43 is located between the center position in the X-axis direction of the second detection target portion H2 and the end portion in the −X direction of the second detection target portion H2.

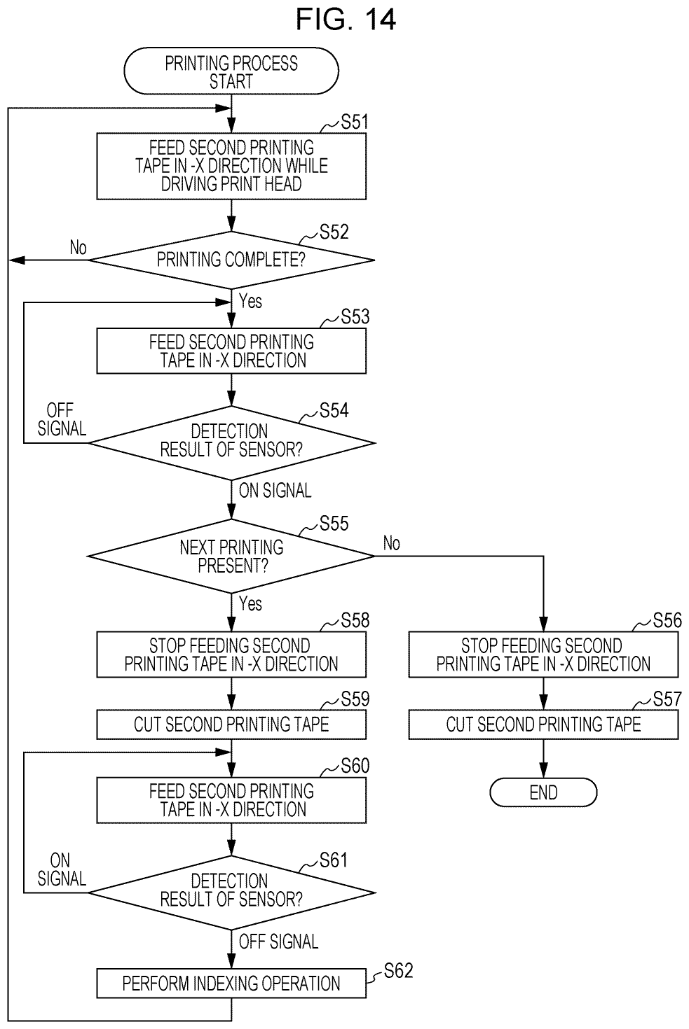

FIG. 14 is a flowchart illustrating the printing process according to the present modification. The printing process is a process that starts after the third indexing process. Since the third indexing process is the same as that in the second embodiment, the description thereof will be omitted.

At step S51, the tape printing apparatus 1 feeds the second printing tape T2 in the −X direction while driving the print head 26. Step S51 is performed based on the print data generated in advance.

At step S52, the tape printing apparatus 1 determines whether or not printing is complete. If it is determined that the printing is complete, the tape printing apparatus 1 proceeds to step S53. In contrast, if it is determined that the printing is not complete, the tape printing apparatus 1 returns to step S51.

At step S53, the tape printing apparatus 1 feeds the second printing tape T2 in the −X direction.

At step S54, the tape printing apparatus 1 determines a detection result of the sensor 43. If it is determined that the detection result of the sensor 43 is the ON signal, the tape printing apparatus 1 proceeds to step S55. In this case, the tape printing apparatus 1 determines that the end of the second detection target portion H2 in the −X direction is detected. Additionally, if it is determined that the detection result of the sensor 43 is the OFF signal, the tape printing apparatus 1 returns to step S53.

At step S55, the tape printing apparatus 1 determines whether the next printing is present or absent. The tape printing apparatus 1 determines based on print data whether the next printing is present or absent. The next printing refers to printing on the plate 61 located in the +X direction of the plate 61 on which printing is complete at step S52. If it is determined that the next printing is present, the tape printing apparatus 1 proceeds to step S58. In contrast, if it is determined that the next printing is absent, the tape printing apparatus 1 proceeds to step S56.

At step S56, the tape printing apparatus 1 stops feeding the second printing tape T2 in the −X direction. If it is determined at step S54 that the detection result of the sensor 43 is the ON signal, the cutting position is located within the range between the plates 61 in the X-axis direction. Therefore, in the present modification, rewinding processing before cutting the second printing tape T2 is unnecessary.

At step S57, the tape printing apparatus 1 cuts the second printing tape T2. After step S57, the tape printing apparatus 1 terminates the printing process.

At step S58, the tape printing apparatus 1 stops feeding the second printing tape T2 in the −X direction. Just as at step S56, in the present modification, the rewinding processing before cutting the second printing tape T2 is unnecessary.

At step S59, the tape printing apparatus 1 cuts the second printing tape T2.

At step S60, the tape printing apparatus 1 feeds the second printing tape T2 in the −X direction.

At step S61, the tape printing apparatus 1 determines a detection result of the sensor 43. If it is determined that the detection result of the sensor 43 is the OFF signal, the tape printing apparatus 1 proceeds to step S62. In this case, the tape printing apparatus 1 determines that the end of the second detection target portion H2 in the +X direction is detected. In contrast, if it is determined that the detection result of the sensor 43 is the ON signal, the tape printing apparatus 1 returns to step S60.

At step S62, the tape printing apparatus 1 performs an indexing operation. A method for performing the indexing operation is the same as in the second embodiment, that is, at step S44 illustrated in FIG. 12.

As described above, the tape printing apparatus 1 according to the present modification cuts the second printing tape T2 based on detection of the end of the second detection target portion H2 in the −X direction. If, using the second printing tape T2 in the present modification illustrated in FIG. 13, the second printing tape T2 was cut based on detection of the end of the second detection target portion H2 in the +X direction as in the second embodiment, rewinding processing of feeding the second printing tape T2 in the +X direction would have to be performed for performing an indexing operation. In contrast, in the present modification, since the second printing tape T2 is cut based on detection of the end of the second detection target portion H2 in the −X direction, rewinding processing may be made unnecessary, leading to a reduction in the job time. Additionally, if the following conditions are satisfied, where the distance in the X-axis direction between the detection position of the sensor 43 and the cutting position of the full cutter 27 is referred to as a sensor-to-cutter distance, rewinding processing may be made unnecessary by cutting the second printing tape T2 based on detection of the end of the second detection target portion H2 in the −X direction. The conditions are that the length from the end of the plate 61 in the −X direction to the end of the second detection target portion H2 in the +X direction be shorter than the sensor-to-cutter distance, and the length from the end of the plate 61 in the −X direction to the end of the second detection target portion H2 in the −X direction be greater than or equal to the sensor-to-cutter distance.

### Second Modification

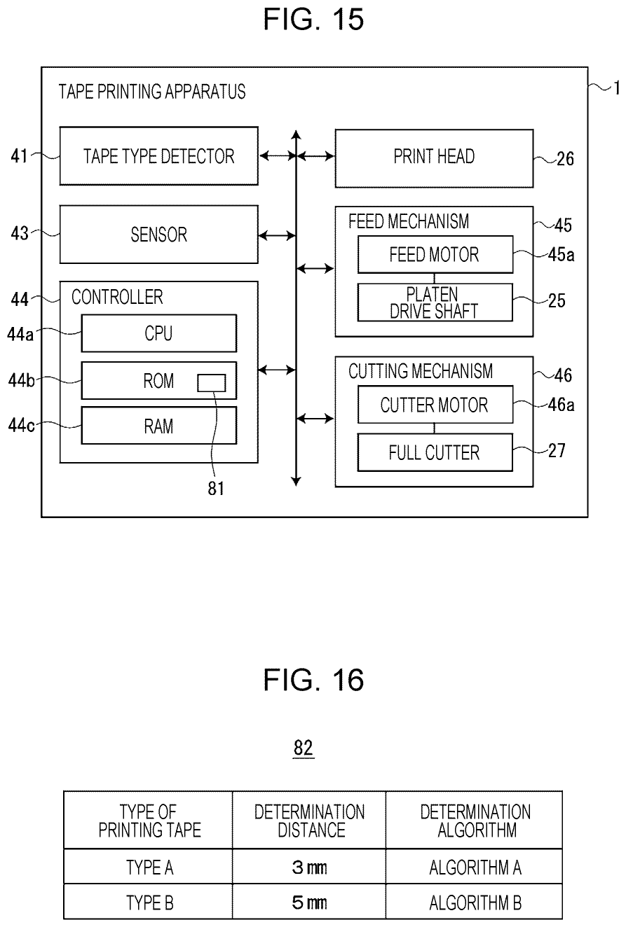

The tape printing apparatus 1 may have a configuration such that one tape printing apparatus 1 is capable of using a plurality of types of printing tapes T. FIG. 15 is a block diagram illustrating a hardware configuration of the tape printing apparatus 1 according to the present modification. The tape printing apparatus 1 according to the present modification includes a tape type detector 41.

The tape type detector 41 detects the type of the printing tape T. The tape type detector 41 detects the type of the printing tape, for example, by optically reading a code image provided on the exterior surface of the tape cartridge C mounted in the cartridge mounting portion 23. In this case, the code image is an image obtained by encoding type information indicating the type of the printing tape T, and is, for example, a two dimensional code or a barcode.

The tape type detector 41 may detect the type of the printing tape T by obtaining type information from a circuit board or a radio frequency identification (RFID) tag, which includes a memory element and is provided in the tape cartridge C.

Additionally, the tape printing apparatus 1 according to the present modification includes a storage 81 in the ROM 44b. A table 82 illustrated in FIG. 16 is stored in the storage 81. The table 82 is information in which the type of the printing tape T, the determination distance, and the determination algorithm are associated with each other. The determination algorithm is information indicating whether it is determined that, when the post-feed output is the ON signal, the ON signal output before the printing tape T is fed by the determination distance is the output due to the detection target portion H being located at the detection position, or it is determined that, when the post-feed output is not the ON signal, the ON signal output before the printing tape T is fed by the determination distance is the output due to the detection target portion H being located at the detection position.

The controller 44 according to the present modification obtains the type of the printing tape T detected by the tape type detector 41. The controller 44 is an example of an obtainer. Additionally, with reference to the table 82, the controller 44 performs an output determination based on a determination distance and a determination algorithm associated with the obtained type of the printing tape T. For example, when “type A” is obtained as the type of the printing tape T, the controller 44 sets the determination distance to “3 mm” and sets “algorithm A” as the determination algorithm. For example, “type A” indicates the type of the first printing tape T1, and “algorithm A” is a determination algorithm for determining that, when the post-feed output is the ON signal, the ON signal output before the printing tape T is fed by the determination distance is the output due to the detection target portion H being located at the detection position.

In such a manner, the tape printing apparatus 1 according to the present modification may support a plurality of types of printing tapes that differ in the determination distance and the determination algorithm, and may reduce the deviation of the printing position due to incorrect detection of the detection target portion H even when any printing tape T is used. Additionally, since the tape printing apparatus 1 includes the tape type detector 41, the tape printing apparatus 1 may automatically obtain the type of a tape.

As a further modification, the tape printing apparatus 1 may obtain the type of the printing tape T input with the operation key group 21. The operation key group 21 is an example of an input section. According to this configuration, the tape printing apparatus 1 may obtain the type of the printing tape T even without the tape type detector 41.

Additionally, as a further modification, in the table 82, the type of the printing tape T and the determination distance may be associated with other, or the type of the printing tape T and the determination algorithm may be associated with each other. In the former case, the tape printing apparatus 1 may perform an output determination based on a determination distance associated with the obtained type of the printing tape T and a predetermined determination algorithm. Additionally, in the latter case, the tape printing apparatus 1 may perform an output determination based on a determination algorithm associated with the obtained type of the printing tape T and a predetermined determination distance.

### Third Modification

In the first and second embodiments, the detection position of the sensor 43 in the Z-axis direction is not necessarily located at substantially the center between the first printing tape T1 and the second printing tape T2. The detection position of the sensor 43 in the Z-axis direction may correspond to the position of the detection target portion H, disposed in the printing tape T, in the Z-axis direction.

### Fourth Modification

In the first and second embodiments, the sensor 43 may be a reflective optical sensor instead of the transmissive optical sensor.

### Fifth Modification

In the first and second embodiments, a mechanical switch may be used instead of the sensor 43. The mechanical switch is an example of the detector. In the present modification, the first printing tape T1 is assumed such that portions corresponding to the first detection target portions H1, which function as the first areas, and the light-transmitting areas 54 are cut out from the mount tape 51. The mechanical switch outputs the first detection value when the first area of the printing tape T being fed in the −X direction or in the +X direction is located at the detection position, that is, when the tip of the mechanical switch penetrates the printing tape T. Additionally, the mechanical switch outputs the second detection value when the second area of the printing tape T is located at the detection position, that is, when the tip of the mechanical switch does not pass through the printing tape T. In such a manner, the tape printing apparatus 1 may achieve the effects of the embodiments described above even when the mechanical switch is used as the detector.

### Sixth Modification

In the first printing tape T1, the first detection target portion H1 may have a shape other than a rectangle. Additionally, in the second printing tape T2, the second detection target portion H2 may have a shape other than a rounded rectangle. Additionally, in the second printing tape T2, the second detection target portion H2 is not necessarily formed in the plate 61 and may be formed in the peripheral portion 62. Additionally, the printing objects arranged on the first printing tape T1 or the second printing tape T2 may be, for example, labels instead of the HSTs 53 or the plates 61. Additionally, the plurality of printing objects arranged on the printing tape T may not necessarily have the same shape and size and may not necessarily be arranged at equal intervals in the X-axis direction.

### Seventh Modification

The tape printing apparatus 1 may not have a configuration in which the tape cartridge C can be mounted. For example, the tape printing apparatus 1 may include a platen roller and may perform printing on the printing tape T supplied from the outside of the tape printing apparatus 1.

### Eighth Modification

The firmware of the tape printing apparatus 1 may be provided as a program to a customer. Alternatively, a storage medium on which the firmware of the tape printing apparatus 1 is recorded may be provided to the customer. Additionally, the tape printing apparatus 1 may employ another printing method such as an ink jet method in addition to a thermal transfer method. Additionally, the feed motor 45a is not limited to a stepping motor and may be another drive motor such as a direct current (DC) motor. In addition, appropriate changes may be made without departing from the gist of the present disclosure.

### Supplementary Note

Hereafter, the tape printing apparatus and the method for controlling the tape printing apparatus will be additionally described.

The tape printing apparatus 1 includes the feed mechanism 45 configured to feed, in the −X direction and in +X direction, the printing tape T including a plurality of printing objects arranged in a length direction of the printing tape T; the print head 26 configured to perform printing on the printing objects of the printing tape T being fed in the −X direction; the sensor 43 configured to, when a detection position is located at a position shifted in the −X direction from a printing position of the print head 26 and a leading end of the printing tape T is located at a position shifted in the +X direction from the detection position and when one of a plurality of first areas of the printing tape T is located at the detection position, output a first detection value, and to, when a second area other than the first areas of the printing tape T is located at the detection position, output a second detection value; and the controller 44. The printing tape T includes a plurality of detection target portions H that are provided respectively for the printing objects and that function as the first areas. The controller 44 is configured to, in response to the sensor 43 outputting the first detection value, control the feed mechanism 45 to feed the printing tape T by a first distance in one of the −X direction and the +X direction, and, depending on whether a post-feed output is the first detection value, the post-feed output being an output of the sensor 43 after the printing tape T is fed by the first distance, perform an output determination for determining whether the first detection value output before the printing tape T is fed by the first distance is an output due to one of the detection target portions H being located at the detection position.

A method for controlling the tape printing apparatus 1 is a method for controlling the tape printing apparatus 1 that includes the feed mechanism 45 configured to feed, in −X direction and in +X direction, the printing tape T including a plurality of printing objects are arranged in a length direction of the printing tape T; the print head 26 configured to perform printing on the printing objects of the printing tape T being fed in the −X direction; and the sensor 43 configured to, when a detection position is located at a position shifted in the −X direction from a printing position of the print head 26 and a leading end of the printing tape T is located at a position shifted in the +X direction from the detection position and when one of a plurality of first areas of the printing tape T is located at the detection position, output a first detection value, and to, when a second area other than the first areas of the printing tape T is located at the detection position, output a second detection value. The printing tape T includes a plurality of detection target portions H that are provided respectively for the printing objects and that function as the first areas. In response to the sensor 43 outputting the first detection value, the tape printing apparatus 1 controls the feed mechanism 45 to feed the printing tape T by a first distance in one of the −X direction and the +X direction, and, depending on whether a post-feed output is the first detection value, the post-feed output being an output of the sensor 43 after the printing tape T is fed by the first distance, determines whether the first detection value output before the printing tape T is fed by the first distance is an output due to one of the detection target portions H being located at the detection position.

According to this configuration, in response to the sensor 43 outputting the first detection value, the tape printing apparatus 1 feeds the printing tape T by the first distance, and, depending on the output after the printing tape T is fed by the first distance is the first detection value, determines whether the first detection value output before the printing tape T is fed by the first distance is an output due to one of the detection target portions H being located at the detection position. As a result, the tape printing apparatus 1 may accurately detect the detection target portion H, leading to a reduction in the deviation of the printing position due to incorrect detection of the detection target portion H.

In the tape printing apparatus 1 described above, it is desirable that the controller 44 be configured to, after obtaining a printing start instruction, control the feed mechanism 45 to feed the printing tape T in the +X direction as the one direction, and configured to, when it is determined in the output determination that the first detection value output before the printing tape T is fed by the first distance is an output due to the detection target portion H being located at the detection position, control the feed mechanism 45 to perform an indexing operation that aligns the printing start position of the printing object with the printing position of the print head 26.

According to this configuration, since the tape printing apparatus 1 performs an output determination by feeding the printing tape T in the +X direction after obtaining the printing start instruction, the printing object is not wasted.

In the tape printing apparatus 1 described above, it is desirable that the sensor 43 be an optical sensor, the printing tape T include one or more light-transmitting areas 54 that are each located between the detection target portions H, have lengths shorter than lengths of the detection target portions H in the −X direction, and function as the first areas, that the first distance be longer in the −X direction than a length of any light-transmitting area 54 of the one or more light-transmitting areas 54, be shorter than the length of any one of the detection target portions H, and be shorter than a length between the first areas, that the controller 44 be configured to, when the post-feed output is the first detection value, determine that the first detection value output before the printing tape T is fed by the first distance is an output due to the one of the detection target portions H being located at the detection position, and that the controller 44 be configured to, when the post-feed output is not the first detection value, determine that the first detection value output before the printing tape T is fed by the first distance is not an output due to the one of the detection target portions H being located at the detection position.

According to this configuration, even when the printing tape T including the light-transmitting areas 54 is used, the tape printing apparatus 1 may reduce the deviation of a printing position due to incorrect detection of the first detection target portion H.

In the tape printing apparatus 1 described above, it is desirable that the sensor 43 be an optical sensor, that the printing tape T include the detection target portions H formed in the printing objects, that the first distance be longer in the −X direction than the length of each of the detection target portions H, and be shorter than the length from the leading end of the printing tape T to an end in the −X direction of one of the detection target portions H located farthest in the −X direction among the plurality of detection target portions H, that the controller 44 be configured to, when the post-feed output is not the first detection value, determine that the first detection value output before the printing tape T is fed by the first distance is an output due to the one of the detection target portions H being located at the detection position, and that the controller 44 be configured to, when the post-feed output is the first detection value, determine that the first detection value output before the printing tape T is fed by the first distance is not an output due to the one of the detection target portions H being located at the detection position.

According to this configuration, even when the printing tape T including the detection target portions H formed in the printing objects is used, the tape printing apparatus 1 may reduce a deviation of the printing position due to incorrect detection of the detection target portion H.

In the tape printing apparatus 1 described above, it is desirable that the tape printing apparatus 1 further include an obtainer configured to obtain a type of the printing tape T and the storage 81 configured to store the table 82 in which the type of the printing tape T is associated with the first distance, and that the controller 44 be configured to, with reference to the table 82, perform the output determination based on the first distance associated with the tape type obtained by the obtainer.

According to this configuration, the tape printing apparatus 1 may cope with a plurality of types of printing tapes T that differ in the first distance, and may reduce a deviation of the printing position due to incorrect detection of the detection target portion H even when any printing tape T is used.

In the tape printing apparatus 1 described above, it is desirable that the tape printing apparatus 1 further include an obtainer configured to obtain a type of the printing tape T, and the storage 81 configured to store the table 82 in which the type of the printing tape T is associated with a determination algorithm of whether it is determined that, when the post-feed output is the first detection value, the first detection value output before the printing tape T is fed by the first distance is an output due to the one of the detection target portions H being located at the detection position, or it is determined that, when the post-feed output is not the first detection value, the first detection value output before the printing tape T is fed by the first distance is an output due to the one of the detection target portions H being located at the detection position, and that the controller 44 be configured to, with reference to the table 82, perform the output determination based on the determination algorithm associated with the type of the printing tape T obtained by the obtainer.

According to this configuration, the tape printing apparatus 1 may cope with a plurality of types of printing tapes T that differ in the determination algorithm, and may reduce a deviation of the printing position due to incorrect detection of the detection target portion H even when any printing tape T is used.

In the tape printing apparatus 1 described above, it is desirable that the tape printing apparatus 1 further include the tape type detector 41 configured to detect a type of the printing tape T, and that the obtainer be configured to obtain the type of the printing tape T detected by the tape type detector 41.

According to this configuration, the tape printing apparatus 1 may automatically obtain the type of the printing tape T.

In the tape printing apparatus 1 described above, it is desirable that the tape printing apparatus 1 further include an input section configured to input a type of the printing tape T, and that the obtainer be configured to obtain the type of the printing tape T input by the input section.

According to this configuration, the tape printing apparatus 1 may obtain the type of the printing tape T even without the tape type detector 41.

What is claimed is:

1. A tape printing apparatus comprising:
a feed mechanism configured to feed, in a first feed direction and in a second feed direction opposite to the first feed direction, a printing tape including a plurality of printing objects arranged in a length direction of the printing tape;
a print head configured to perform printing on the printing objects of the printing tape being fed in the first feed direction;
a detector configured to, when a detection position is located at a position shifted in the first feed direction from a printing position of the print head and a leading end of the printing tape is located at a position shifted in the second feed direction from the detection position and when one of a plurality of first areas of the printing tape is located at the detection position, output a first detection value, and to, when a second area other than the first areas of the printing tape is located at the detection position, output a second detection value; and
a controller, wherein
the printing tape includes a plurality of detection target portions that are provided respectively for the printing objects and that function as the first areas, and
the controller is configured to, in response to the detector outputting the first detection value, control the feed mechanism to feed the printing tape by a first distance in one of the first feed direction and the second feed direction, and to, depending on whether a post-feed output is the first detection value, the post-feed output being an output of the detector after the printing tape is fed by the first distance, perform an output determination for determining whether the first detection value output before the printing tape is fed by the first distance is an output due to one of the detection target portions being located at the detection position.

2. The tape printing apparatus according to claim 1,
wherein the controller is configured to, after obtaining a printing start instruction, control the feed mechanism to feed the printing tape in the second feed direction as the one direction, and to, when it is determined in the output determination that the first detection value output before the printing tape is fed by the first distance is an output due to the one of the detection target portions being located at the detection position, control the feed mechanism to perform an indexing operation that aligns a printing start position of the printing object with the printing position of the print head.

3. The tape printing apparatus according to claim 2, wherein
the detector is an optical sensor,
the printing tape includes one or more light-transmitting areas that are each located between the detection target portions, have lengths shorter than lengths of the detection target portions in the first feed direction, and function as the first areas,
the first distance is longer in the first feed direction than a length of any one of the one or more light-transmitting areas, is shorter than the length of any one of the detection target portions, and is shorter than a length between the first areas,
the controller is configured to, when the post-feed output is the first detection value, determine that the first detection value output before the printing tape is fed by the first distance is an output due to the one of the detection target portions being located at the detection position, and
the controller is configured to, when the post-feed output is not the first detection value, determine that the first detection value output before the printing tape is fed by the first distance is not an output due to the one of the detection target portions being located at the detection position.

4. The tape printing apparatus according to claim 2, wherein
the detector is an optical sensor,
the printing tape includes the detection target portions formed in the printing objects,
the first distance is longer in the first feed direction than a length of each of the detection target portions, and is shorter than a length from the leading end of the printing tape to an end in the first feed direction of one of the detection target portions located farthest in the first feed direction among the plurality of detection target portions,
the controller is configured to, when the post-feed output is not the first detection value, determine that the first detection value output before the printing tape is fed by the first distance is an output due to the one of the detection target portions being located at the detection position, and
the controller is configured to, when the post-feed output is the first detection value, determine that the first detection value output before the printing tape is fed by the first distance is not an output due to the one of the detection target portions being located at the detection position.

5. The tape printing apparatus according to claim 1, further comprising:
an obtainer configured to obtain a type of the printing tape; and
a storage configured to store a table in which the type of the printing tape is associated with the first distance, wherein
the controller is configured to, with reference to the table, perform the output determination based on the first distance associated with the type of the printing tape obtained by the obtainer.

6. The tape printing apparatus according to claim 1, further comprising:
an obtainer configured to obtain a type of the printing tape; and
a storage configured to store a table in which the type of the printing tape is associated with a determination algorithm of whether it is determined that, when the post-feed output is the first detection value, the first detection value output before the printing tape is fed by the first distance is an output due to the one of the detection target portions being located at the detection position, or it is determined that, when the post-feed output is not the first detection value, the first detection value output before the printing tape is fed by the first distance is an output due to the one of the detection target portions being located at the detection position, wherein
the controller is configured to, with reference to the table, perform the output determination based on the determination algorithm associated with the type of the printing tape obtained by the obtainer.

7. The tape printing apparatus according to claim 5, further comprising:
a tape type detector configured to detect a type of the printing tape, wherein
the obtainer is configured to obtain the type of the printing tape detected by the tape type detector.

8. The tape printing apparatus according to claim 5, further comprising:
an input section configured to input a type of the printing tape, wherein
the obtainer is configured to obtain the type of the printing tape input by the input section.

9. A method for controlling a tape printing apparatus, the tape printing apparatus including
a feed mechanism configured to feed, in a first feed direction and in a second feed direction opposite to the first feed direction, a printing tape including a plurality of printing objects are arranged in a length direction of the printing tape,
a print head configured to perform printing on the printing objects of the printing tape being fed in the first feed direction, and
a detector configured to, when a detection position is located at a position shifted in the first feed direction from a printing position of the print head and a leading end of the printing tape is located at a position shifted in the second feed direction from the detection position and when one of a plurality of first areas of the printing tape is located at the detection position, output a first detection value, and to, when a second area other than the first areas of the printing tape is located at the detection position, output a second detection value, wherein
the printing tape includes a plurality of detection target portions that are provided respectively for the printing objects and that function as the first areas,
the method being executed by the tape printing apparatus, the method comprising:
in response to the detector outputting the first detection value, controlling the feed mechanism to feed the printing tape by a first distance in one of the first feed direction and the second feed direction; and, depending on whether a post-feed output is the first detection value, the post-feed output being an output of the detector after the printing tape is fed by the first distance, determining whether the first detection value output before the printing tape is fed by the first distance is an output due to one of the detection target portions being located at the detection position.
